(19) United States
(12) Patent Application Publication
(10) Pub. No.: US 2011/0169932 A1
(43) Pub. Date: Jul. 14, 2011

(54) Wireless Facial Recognition

(75) Inventors: Paul Salvador Mula, San Jose, CA (US); Kenneth S. Bailey, San Jose, CA (US)

(73) Assignee: CLEAR VIEW TECHNOLOGIES INC., San Jose, CA (US)

(21) Appl. No.: 12/985,522

(22) Filed: Jan. 6, 2011

Related U.S. Application Data
(60) Provisional application No. 61/335,384, filed on Jan. 6, 2010.

(51) Int. Cl. H04N 7/18; H04N 5/225; G06K 9/00

(52) U.S. Cl. 348/77; 348/207.1; 382/118; 348/E07.088; 348/E05.024

(57) ABSTRACT

Identifying individuals ad-hoc by a user wearing specially designed glasses that include a hidden internal display screen that can be seen only by the user or wearer of the glasses that is wirelessly linked to a central database to determine via facial imaging techniques the identity of the person or persons standing in front of the user or wearer of the glasses. Information can be obtained from a social networking site which can include age, marital status, preferences, vices and habits, ethnic background, frequently viewed websites, personality traits, dating habits, color preferences, educational background, criminal history, family history, average annual income, religious beliefs, clubs memberships, associations, date of birth, and other such individual data. The information can be instantly provided to the user of the glasses, to help in identifying local people.

This application claims priority from provisional application No. 61/335,384, filed Jan. 6, 2010, the entire contents of which are herewith incorporated by reference.

### BACKGROUND

Facial imaging has been prevalent in the World since the invention of the pen in 3,000 B.C. and the paintbrush in the 1100's. Earlier cavemen demonstrated cave paintings as early as 40,000 B.C. Notwithstanding, the invention of the early cameras in 1814 ushered in a new era of photography and the capture of the facial image. Since 1885, with the invention of film by George Eastman, the manufacturer and founder of Kodak have been using film to capture both still and motion images.

Modern cameras can capture 21 megapixels per frame in still cameras and 2,000,000 pixels per frame in video imaging solutions.

In November of 1990, Professor Matthew Turk and Alex P. Pentland of the Massachusetts Institute of Technology invented facial imaging technology now commonly referred to as “eigenface” to represent, locate, and identify faces. Subsequent improvements to the Turk, Pentland patents by others including Jay F. Bortolussi and Francis J. Cusack Jr., (U.S. Pat. No. 6,296,575) have resulted in the facial recognition technologies in practice today by their Company, Visage Technologies, Inc., in Las Vegas Casinos, and by various Government Agencies.

The basic concept is to recognize a person or person(s) in a crowd of people to determine their true identity or positive identification for gaining access to a building, an area of a building, or for screening undesirables from the premises, such as gambling cheats or conspirators.

These earlier devices and machines were not portable, were very expensive, and were not able to be acquired by the average person.

### SUMMARY

Embodiments describe a portable, wearable recognition device and portions of the recognition device. An embodiment is designed to be utilized by individuals, as compared with many of these other systems that were intended to be used only by businesses with mainframes.

### BRIEF DESCRIPTION OF THE DRAWINGS

in the drawings:

FIG. 1 depicts the glasses system components as might be found in an embodiment;

FIG. 2 depicts the system connectivity to the look-up databases and transceivers from the glasses;

FIG. 3 depicts a systems flow chart as might be used to determine how the system functions under normal operating conditions.

FIG. 4 depicts the system server computer configuration and how the search for data is carried out under normal operating conditions.

FIG. 5 depicts the wearer's video screen(s) example as might be viewed by the wearer or user during an operating session.

FIG. 6 depicts the flow chart of the embedded system algorithm used to determine the facial features and characteristics of the person being identified.

### DETAILED DESCRIPTION

An embodiment describes to a wireless device that connects to a collection of readily available Social Network type internet websites. Exemplary Social Networking sites include sites such as MySpace, YouTube, FaceBook, Intelius, Classmates, Friendster, Bebo, Yahoo Personals, Google, Linkedin, Match.com, and other social networks. More generally, any website or other platform, where people can obtain information about any other people can be used herein and are referred to as “social networking sites”. The system as described herein can also be used with public information sources.

This connectivity is simplified by a host platform server, which searches various sites for information on the person that is being identified, using facial imaging techniques and creates an index that can be more quickly searched.

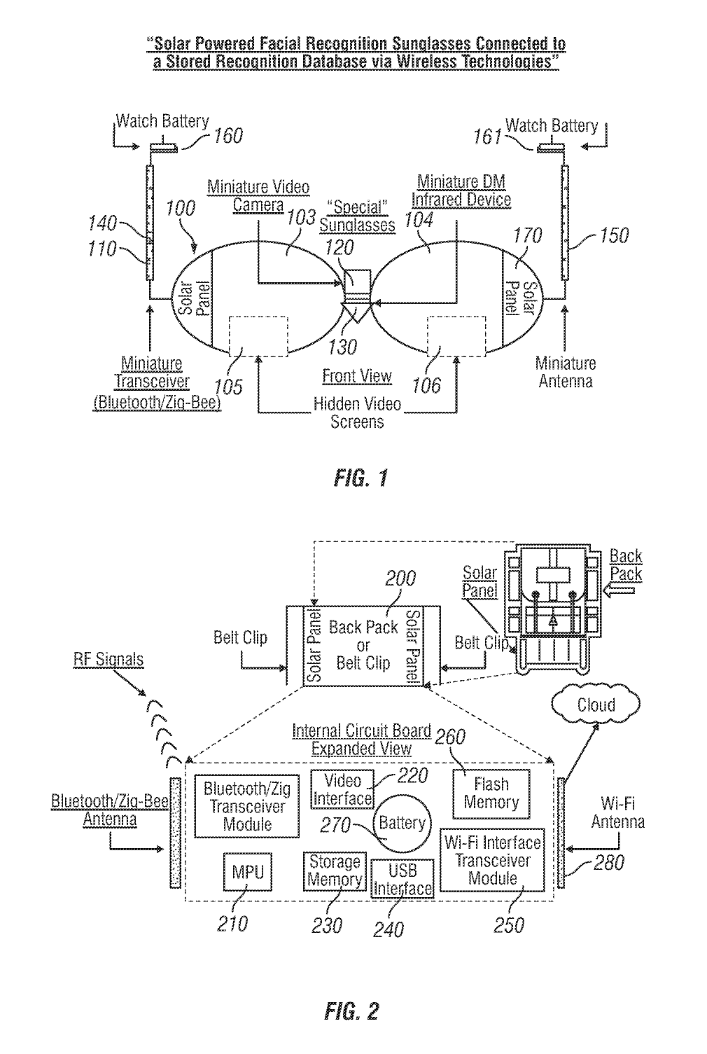

In an embodiment, a user is wearing specially modified sunglasses 100 as shown in FIG. 1, that are battery powered, and contain firmware and/or software that reduces facial images utilizing the techniques as described herein. The glasses database, which can be local or remote, using the communication structure shown in FIG. 2.

In one embodiment, the database for the facial recognition device may have the ability to search a preset set of websites, and/or to allow a user to enter new websites to be searched. According to another embodiment, an index of this information is obtained and locally stored.

In one embodiment, there can be a miniature video screen 105, 106 or other display that displays the findings.

Once the user has identified the person of interest, the user may then approach the person to strike up a conversation based upon information from their common interests, ethnic background, social interests, hobbies, school affiliations, business affiliations, family history, sports, and the like information that is conventionally obtained from websites of this type.

The user of the system described herein can be a student, politician, law enforcement officer, military officer, single person, married person, teacher, diplomat, fireman, engineer, sports figure, scientist or inventor. The device can be used at trade shows and conventions, lecture halls, college campuses, nightclubs, restaurants, athletic clubs, social gatherings, weddings, reunions, public hearings and the like.

In the interest of privacy to those individuals who may take offence to the idea of being profiled by other members of the general populace, (as opposed to law enforcement agents), by this device and system, the embodiment may only link the device to networks that offer personal information supplied by the person giving the personal information to a public platform that anyone can access. For example, when linking this device to Facebook, this can obtain for example only the publicly available profile information from Facebook.

FIG. 1 shows a block diagram of the image acquisition and information displaying system. A modified pair of sunglasses 100 is used which incorporate one or more miniature video screens 105,106 which is concealed behind the glasses lens 103, 104 such that only the wearer can view the screen. More generally, any kind of conventional eyeglasses can be used with randomness, arms, places for lenses, and other conventional parts that are used on eyeglasses. As conventional, any kind of glasses can be used, for example the lenses can include rims or be rimless, and the arms can be either connected to the rims or directly connected to the glasses. A video camera 120 is used to obtain video or still pictures of an area at which the user is looking. An infrared device 130 obtains infrared information for measuring distance, for example, in an embodiment where biometric discrimination may be carried out of the users in order to further reduce the set. A miniature transceiver 110 may use a wireless technology modem such as Wi-fi, Bluetooth, Zig-Bee or WiMAX that links the system including the camera 120, screens 105, 106, and the other information miniature video screen to a central database server.

Many of the components may be built into the arm of the glasses, or otherwise integrated within the glasses. For example, the transceiver 110 is built into one arm of the glasses, and the processor and memory forms a miniaturized computer 140 that is built into that arm of the glasses. The other arm of the glasses 150 may form a miniature antenna that is used for the wireless communication. The end most portion of the two arms of the glasses receive rechargeable batteries 160, 161. A solar panel 170 can be used for recharging the onboard batteries.

In embodiments, the miniaturized processor and memory 140 may include an MPU, a storage memory, a flash memory, a wired and/or wireless USB interface, a video interface and others. In another embodiment, the transceiver 110 may communicate with a processor that is in some other location, for example in a belt clip or backpack.

FIG. 2 shows the the processing part according to an embodiment where the processor 200 is separate from the glasses, in a backpack or belt clip, and also shows an expanded view of the processor. The processor as shown includes a processor unit 210, a video interface 220 which is optimized for displaying information on the video screens 105, 106, a storage memory 230, a USB interface 240, Wi-Fi transceiver 250 and flash memory 260. The batteries can be built within the arms of the glasses as 160, and/or there can be a separate larger battery 270 within the separated belt clip. The belt clip can also include a Wi-Fi antenna shown as 280. In one embodiment, the processor in the belt clip or backpack can communicate with the glasses, to receive information therefrom and sends information thereto.

The information as sent can be compared with any number of social networking sites and specifically the publicly available information from those sites. Example sites can be, as described above, MySpace, Facebook, U-search, reverse directory, classmates, LinkedIn, LEXIS-NEXIS, Model Mayhem, Who's Who. This can also use other information sites such as Google, a law enforcement database, or other information sites.

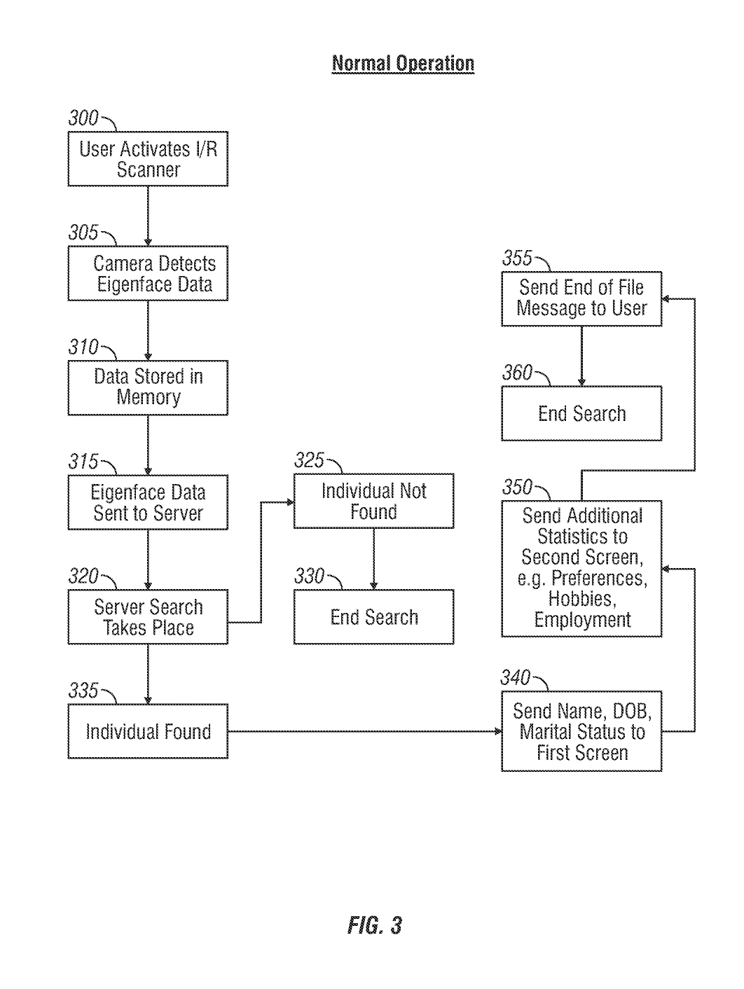

FIG. 3 illustrates a normal operation of the system. At 300, the user activates the infrared scanner, and the camera at 305 detects face data, which can be any information that indicates the face, but more specifically can be an indication of an eigenface.

The data is stored in memory at 310, and sent to the server at 315. This causes a server search to take place at 320. If the individual is not found at 325, the search is ended at 330. However, if the individual is found at 335, then personal information such as the name of the user, their date of birth, marital status and the like is sent to the first screen to be displayed to the user. More generally, any information that is public or otherwise available information from one of these websites can be obtained and sent in this embodiment. Beyond the name information, at 350, additional information such as the user's likes and dislikes as well as other people on their network can be sent at 350. After the information is sent, the process is ended at 355 and end the file messages sent and search is ended at 360.

Also, as described above according to another embodiment, the server may store indexes of faces; for example in the server may be local or remote.

The server information may be carried out in a remote server that is remote from computer 200, or more generally can be carried out in any computer.

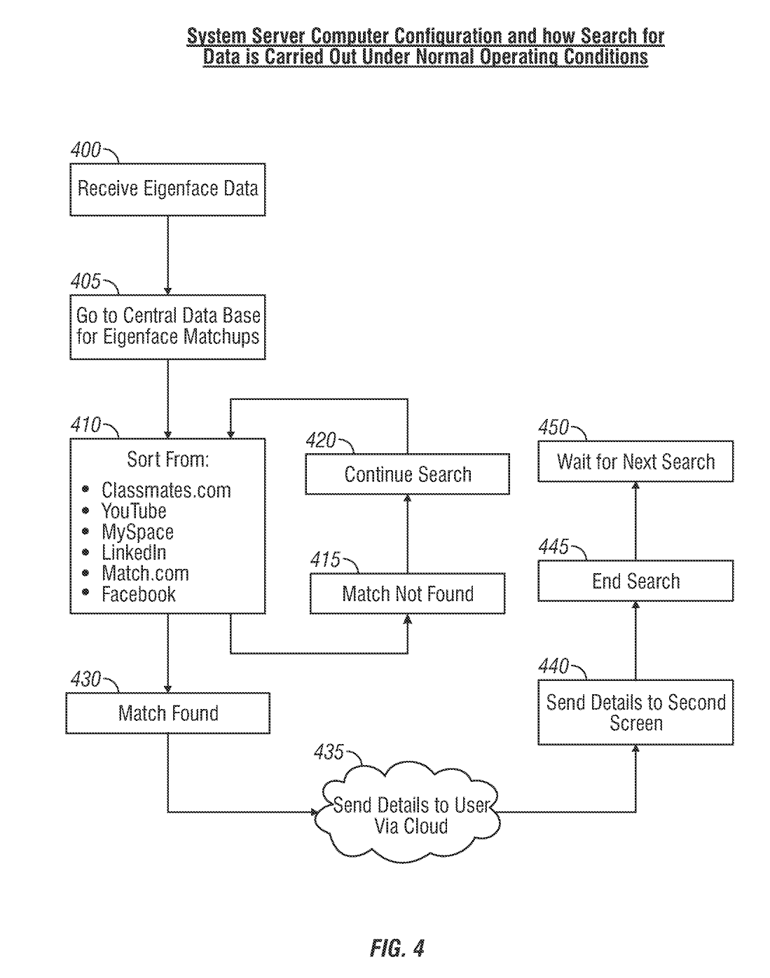

FIG. 4 shows an operation where at 400 the system receives eigenface data, and goes to the central database to match at 405. At 410, a list of associated websites such as classmates, YouTube, MySpace, LinkedIn, match.com and Facebook is obtained. If no match is found at 415, the search may be continued or ended at 420. However, if the match is found at 430, the user is sent details from the social networking site at 435 which is displayed on the screen at 440. The search then ends at 445 and waits for the next search at 450.

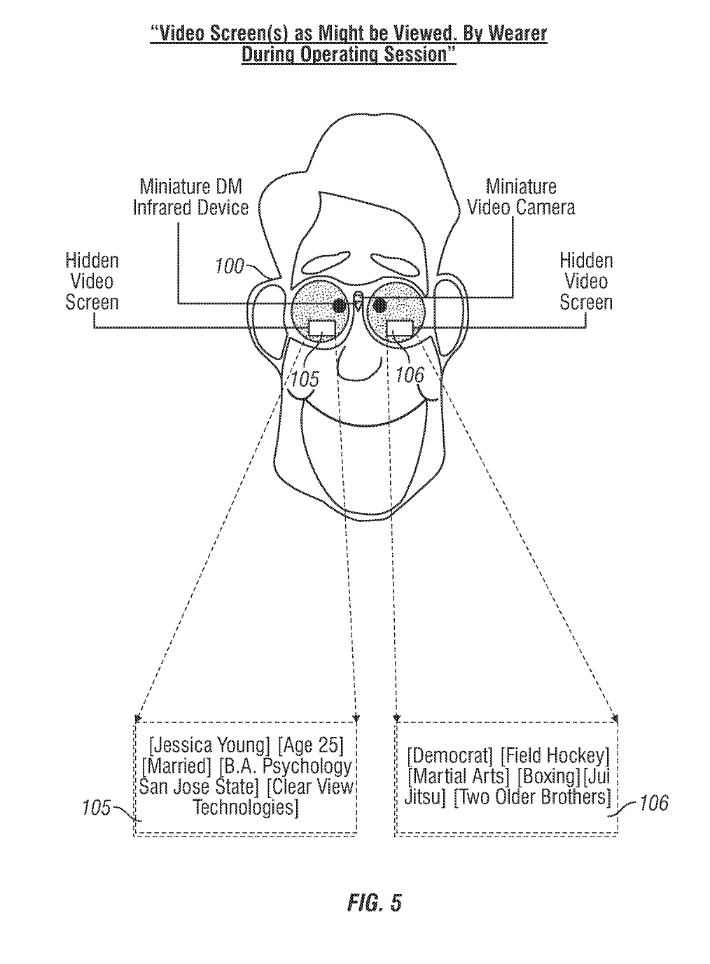

FIG. 5 illustrates the operation of the system and what is seen during an operating session. This shows the glasses 100 with video screens 105, 106. Video screen 105 is displaying the user's information; e.g., their name age, and other information about the user. The other screen 106 is showing the user's interests. All of this can be obtained by recognizing the face of the person being looked at, so that the system can automatically obtain this information.

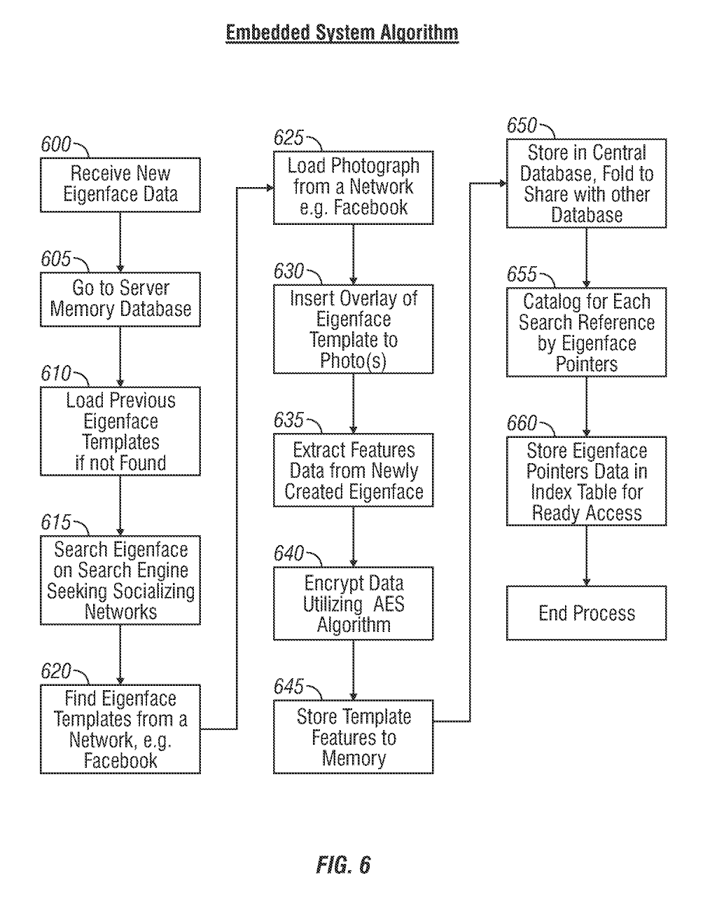

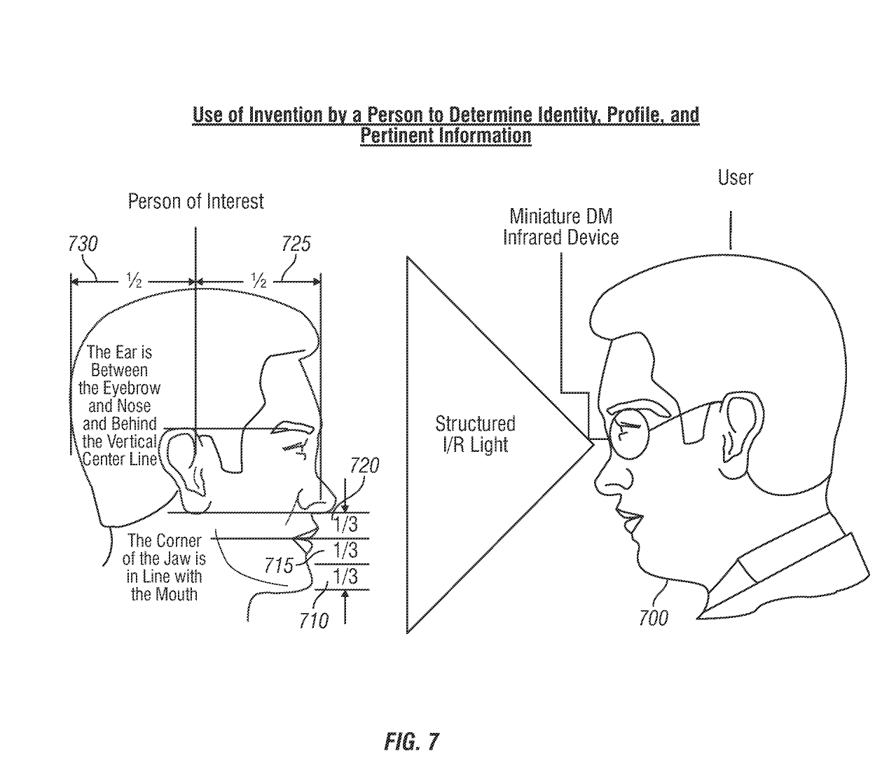

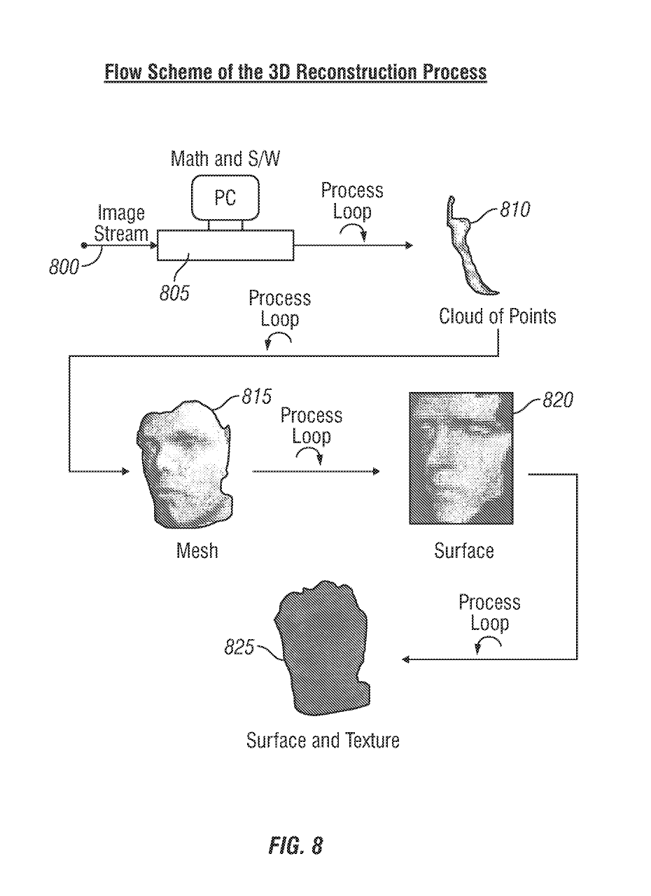

FIG. 6 shows an overall flowchart of operation according to an embodiment. At 600, the system receives new eigenface data which goes to the server database at 605.

At 610, the system loads the previous site interface templates that they have not been found. 615 searches for this on search engines and 620 finds the templates from one of these networks for example Facebook.

At 625, the system loads the photograph from the network and inserts the overlay of the face over the photo at 630. Features are extracted at 635, and may be optionally encrypted at 640. The template is then stored in memory at 645 and stored in the central database at 650.

Each search reference is catalogued and pointers are used to search. This may form an index at 660 enabling more easy searching especially when the system is used for example in a room of people who one sees over and over again. In this embodiment, therefore, the system can actually be used to keep track of names associated with faces to assist the user in remembering people's names.

FIG. 7 illustrates the use of the hardware of the technique to determine identity profile and other information. In one embodiment, the camera on the user 700 is receiving both white and structured infrared light through the infrared detector. This can be used to characterize the person of interest biometrically. For example, one embodiment can obtain various measurements of the person's face which can be used to identify the person either relative to a database or in general. As shown, the face detection may be supplemented by determining measurement information representative of the person's face, for example the distance 710 between the bottom of their chin and the indentation on the chin; the distance 715 between the indentation in the midpoint of their lips; the distance 720 between the midpoint of their lips and the bottom of their nose; the distance 725 between the most forward portion of their forehead and the midpoint of the frontal lobe of their ear; the distance 730 between the vertical centerline of their ear, and the back of their head. Any distance of this type can be used to catalog a person. This can be used for assisting the database of facial recognition or for the recognition itself.

FIG. 8 shows a 3-D reconstruction process which can be used. An image stream from the video camera is obtained at 800, and sent to the processor 805 which may be the local processor or may be a processor that is remote from the rest of the device. The processor processes the information to first obtain a cloud of points 810, refine that to a mesh at 815, to refine that to a surface at 820, and finally to textures at 825. The points, match, surface and textures can each be used within the recognition process.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example other hardware and software can be used. Moreover, while this describes use with certain specified kinds of facial recognition, any kind of facial recognition or more generally any kind of biometric recognition can be used. Moreover, other kinds of processors and processing equipment can be used.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments of the invention.

The various illustrative logical blocks, modules, and circuits described in connection with the embodiments disclosed herein, may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. The processor can be part of a computer system that also has a user interface port that communicates with a user interface, and which receives commands entered by a user, has at least one memory (e.g., hard drive or other comparable storage, and random access memory) that stores electronic information including a program that operates under control of the processor and with communication via the user interface port, and a video output that produces its output via any kind of video output format, e.g., VGA, DVI, HDMI, displayport, or any other form.

When operated on a computer, the computer may include a processor that operates to accept user commands, execute instructions and produce output based on those instructions. The processor is preferably connected to a communication bus. The communication bus may include a data channel for facilitating information transfer between storage and other peripheral components of the computer system. The communication bus further may provide a set of signals used for communication with the processor, including a data bus, address bus, and/or control bus.

The communication bus may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or any old or new standard promulgated by the Institute of Electrical and Electronics Engineers (“IEEE”) including IEEE 488 general-purpose interface bus (“GPIB”), and the like.

A computer system used according to the present application preferably includes a main memory and may also include a secondary memory. The main memory provides storage of instructions and data for programs executing on the processor. The main memory is typically semiconductor-based memory such as dynamic random access memory (“DRAM”) and/or static random access memory (“SRAM”). The secondary memory may optionally include a hard disk drive and/or a solid state memory and/or removable storage drive for example an external hard drive, thumb drive, a digital versatile disc (“DVD”) drive, etc.

At least one possible storage medium is preferably a computer readable medium having stored thereon computer executable code (i.e., software) and/or data thereon in a non-transitory form. The computer software or data stored on the removable storage medium is read into the computer system as electrical communication signals.

The computer system may also include a communication interface. The communication interface allows' software and data to be transferred between computer system and external devices (e.g. printers), networks, or information sources. For example, computer software or executable code may be transferred to the computer to allow the computer to carry out the functions and operations described herein. The computer system can be a network-connected server with a communication interface. The communication interface may be a wired network card, or a Wireless, e.g., Wifi network card.

Software and data transferred via the communication interface are generally in the form of electrical communication signals.

Computer executable code (i.e., computer programs or software) are stored in the memory and/or received via communication interface and executed as received. The code can be compiled code or interpreted code or website code, or any other kind of code.

A “computer readable medium” can be any media used to provide computer executable code (e.g., software and computer programs and website pages), e.g., hard drive, USB drive or other. The software, when executed by the processor, preferably causes the processor to perform the inventive features and functions previously described herein.

A processor may also be implemented as a combination of computing devices, e.g., a combination of a DSP and a microprocessor, a plurality of microprocessors, one or more microprocessors in conjunction with a DSP core, or any other such configuration. These devices may also be used to select values for devices as described herein.

The steps of a method or algorithm described in connection with the embodiments disclosed herein may be embodied directly in hardware, in a software module executed by a processor, or in a combination of the two. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. The memory storage can also be rotating magnetic hard disk drives, optical disk drives, or flash memory based storage drives or other such solid state, magnetic, or optical storage devices. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media. The computer readable media can be an article comprising a machine-readable non-transitory tangible medium embodying information indicative of instructions that when performed by one or more machines result in computer implemented operations comprising the actions described throughout this specification.

Operations as described herein can be carried out on or over a website. The website can be operated on a server computer, or operated locally, e.g., by being downloaded to the client computer, or operated via a server farm. The website can be accessed over a mobile phone or a PDA, or on any other client. The website can use HTML code in any form, e.g., MHTML, or XML, and via any form such as cascading style sheets (“CSS”) or other.

Also, the inventors intend that only those claims which use the words “means for” are intended to be interpreted under 35 USC 112, sixth paragraph. Moreover, no limitations from the specification are intended to be read into any claims, unless those limitations are expressly included in the claims. The computers described herein may be any kind of computer, either general purpose, or some specific purpose computer such as a workstation. The programs may be written in C, or Java, Brew or any other programming language. The programs may be resident on a storage medium, e.g., magnetic or optical, e.g. the computer hard drive, a removable disk or media such as a memory stick or SD media, or other removable medium. The programs may also be run over a network, for example, with a server or other machine sending signals to the local machine, which allows the local machine to carry out the operations described herein.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A system, comprising:
an eyeglasses frame, including first and second lenses, and first and second arms, connected to the lenses,
said frame including attached thereto, at least one camera which obtains a photo of a person at which at least one portion of the frame is being pointed, and said camera connected to at least one wireless communication device which sends information from the camera to a remote location.

2. The system as in claim 1, wherein said camera is mounted on a location between said first and second lenses.

3. The system as in claim 1, further comprising an antenna for said wireless communication device, said antenna built into one of said first and second arms.

4. The system as in claim 1, further comprising at least one video screen, built into an inside portion of at least one of said lenses.

5. The system as in claim 4, wherein said wireless communication device receives information that is displayed on said at least one video screen.

6. The system as in claim 5, wherein there are two video screens, one on each of the inside of each lens.

7. The system as in claim 6, further comprising a video driver that creates different information for each of said two screens.

8. The device as in claim 5, further comprising an infrared detection device, that detects distance information about a remote object, and communicate said distances information using said wireless communication device.

9. The system as in claim 1, further comprising a computing device, that obtains information from said camera, and compares that information with information from an Internet-based social networking site, to compare image information from said camera with image information from said Internet-based social networking site, and to recognize a person based on said compare.

10. The system of claim 4, further comprising a computing device, that obtains information from said camera, and compares that information with information from an Internet-based social networking site, to compare image information from said camera with image information from said site, and to recognize a person based on said information, and wherein said computing device also sends information that is based on said recognize, from said Internet-based site to said video screen.

11. The system of claim 9, wherein said computing device stores and index of people to be recognized, and compares images with said index.

12. A method of recognizing faces based on information received by a local device, comprising:
receiving an image of a face on a camera device that is attached to a face of a user;
sending information from said camera device to a remote computer using a wireless communication device which is attached to said face of said user; and
receiving information and displaying said information to the user on a device that is attached to said face of said user.

13. The method as in claim 12, wherein said device that is attached to said face of said user includes an eyeglasses frame, including first and second lenses, and first and second arms, connected to the lenses, wherein said camera is mounted on a location between said first and second lenses.

14. The method as in claim 13, wherein said sending and receiving uses an antenna for said wireless communication device, said antenna built into one of said first and second arms.

15. The method as in claim 12, further comprising obtaining biometric distance information from said device attached to said facing said user, and communicating said biometric distance information to said remote computer.

16. The method as in claim 12, wherein said receiving information comprises receiving information based on comparing said information from said camera with an Internet-based social networking site.

17. The method as in claim 16, wherein said receiving information receives information identifying a person associated with said face and uniquely indicative of said person.

18. A method of recognizing faces, comprising:
obtaining information indicative of the number of faces of people from one or more social networking websites;
storing information indicative of the faces of the people, said information indicative of an index of said faces of said people;
receiving information indicative of a face;
comparing said information to said index; and returning information from the index to a remote location, said information including at least an identity and at least one other piece of information from the social networking website.

19. A method as in claim 18, further comprising receiving information indicative of biometric characteristics, and wherein said comparing use of said information indicative of the face and also said information indicative of said biometric characteristics.
